(19) United States
(12) Patent Application Publication
(10) Pub. No.: US 2019/0178637 A1
(43) Pub. Date: Jun. 13, 2019

(54) DEVICE FOR ALIGNING AN ANGLE MEASURING INSTRUMENT

(71) Applicant: KEBA AG, Linz (AT)

(72) Inventors: Thomas Funcke-Lehner, Eidenberg (AT); Gernot Preisinger, Linz (AT)

(21) Appl. No.: 16/326,987

(22) PCT Filed: Aug. 2, 2017
(86) PCT No.: PCT/AT2017/050021

§ 371 Date: Feb. 21, 2019

(30) Foreign Application Priority Data
Aug. 24, 2016 (AT) A 50761/2016

(51) Int. Cl. G01B 11/26; B21C 51/00

(52) U.S. Cl. CPC G01B 11/26; B21C 51/00

(57) ABSTRACT

A device is described for aligning an angle measuring device (1) in relation to two workpiece planes (2, 3) enclosing an angle to be measured, wherein the angle measuring device (1) has a rotating mirror (8) for deflecting a laser beam (10) perpendicular to the axis of rotation (7) of the mirror (8). To provide advantageous alignment conditions, it is proposed that an orientation stop (13), which defines a stop straight line (14), which is parallel to the axis of rotation (7) of the mirror (8), for both workpiece planes (2, 3), is assigned to the angle measuring device (1).

### TECHNICAL AREA

The invention relates to a device for aligning an angle measuring device in relation to two workpiece planes enclosing an angle to be measured, wherein the angle measuring device has a rotating mirror for deflecting a laser beam perpendicularly to the axis of rotation of the mirror.

Measuring devices are known for the contactless measurement of a bending angle between the legs of a plate to be bent in a bending machine (JP 2002-59217 A), in which the circumstance is utilized that the radiation intensity of a laser beam reflected on the leg of the plate and received in the emission direction is greatest when the laser beam is incident perpendicularly on the plate leg. For this purpose, a mirror is provided in the region of the upper tool of the bending machine, which mirror is rotated about an axis parallel to the vertex axis of the bending angle and is inclined at 45° to this axis of rotation, so that a laser beam incident on the mirror in the direction of this axis of rotation is deflected in a plane perpendicular to the axis of rotation onto the legs of the plate to be bent and is reflected from the legs, specifically in the emission direction if the laser beam is perpendicular to the respective leg. The respective angle between the two legs can be determined in a signal processing unit via the associated rotational position of the drive motor for the mirror. However, to fit typical bending machines with such measuring devices, these bending machines are to be adapted in design, which makes retrofitting bending machines with measuring devices of this type complex. It has therefore been proposed that such measuring devices be combined in a housing, in order to provide a handheld device which does not require any refitting work on the bending machines. However, because of the measuring principle it is necessary to align the angle measuring device in relation to the workpiece planes, the mutual angle of which is to be measured, in such a way that the plane of the deflected laser beam defined by the rotating mirror is perpendicular to the workpiece planes, which is linked to difficulties if the angle measuring device is merely handled.

### DESCRIPTION OF THE INVENTION

The invention is therefore based on the object of providing a device for accurately aligning angle measuring devices of the described type in relation to the workpiece planes, whose angle enclosed between them is to be measured, without endangering the simple handling of the angle measuring device or obstructing the measuring procedure.

Proceeding from a device of the type described at the outset, the invention achieves the stated object in that an orientation stop is assigned to the angle measuring device, which orientation stop defines a stop straight line parallel to the axis of rotation of the mirror for both workpiece planes.

Because of the circumstance that the orientation stop defines a stop straight line parallel to the axis of rotation of the mirror for the two workpiece planes, the axis of rotation of the mirror has to extend parallel to the geometrical intersection line between the two workpiece planes, and thus parallel to the vertex axis formed by this intersection line of the angle enclosed between the workpiece planes, whereby the condition is met that the plane of the deflected laser beam defined by the rotating mirror is perpendicular to the workpiece planes. The angle measuring device is accordingly to be introduced between the two workpiece planes so that the orientation stop is supported with the aid of the stop straight lines in relation to the two workpiece planes. The fact that in the case of such an alignment the rotational position of the angle measuring device in relation to the two workpiece planes with respect to the axis of rotation of the mirror is not predefined, as long as no additional support is provided in relation to a workpiece plane, does not play a role, because only the axis of rotation of the mirror parallel to the vertex axis of the angle is important in the alignment of the angle measuring device, if it is ensured that the deflected laser beam can be incident perpendicularly on both workpiece planes, which can be ensured without difficulties during handling of the angle measuring device, in particular if the distance of the axis of rotation of the mirror from the two workpiece planes defined by the orientation stop is restricted. Only two stop points of the orientation stop are required for defining a corresponding stop straight line.

However, the orientation stop does not have to define a separate stop straight line for each workpiece plane if the two workpiece planes intersect in an edge, because in this case a stop straight line interacting with this intersection edge bears on both workpiece planes. If this intersection edge is not accessible or is not present, the orientation stop thus has to define a separate stop straight line for each workpiece plane. If the intersection edge between the two workpiece planes is freely accessible, the orientation stop can thus advantageously comprise an orientation ruler which can be supported in the intersection edge.

If the orientation stop has a stop cylinder, which does not have to be circular, parallel to the axis of rotation of the mirror, the generators of this stop cylinder thus form the stop straight lines as a function of the size of the angle to be measured. The workpiece planes extend tangentially to the stop cylinder in this case. However, the stop cylinder does not have to have a cylindrical structural form, but rather merely has to define a geometrical cylinder formed by way of stop points which specify a cylinder form, as is possible, for example, using two spheres or spherical segments arranged at a mutual distance in the direction of the axis of rotation of the mirror.

In order that the orientation stop cannot shade the workpiece planes in relation to the laser beam, it can have two stop sections on both sides of the plane of the deflected laser beam defined by the rotating mirror. Moreover, this support on both sides of the laser beam plane facilitates the angle measurement in workpieces having a comparatively short extension in the direction of the vertex axis of the angle to be measured. However, such shading can be entirely desirable in order to suppress reflections which impair the measurement result in the region of bending edges having larger bending radii. For this purpose, the orientation stop can shade the workpiece in the region of the bending edge in relation to the laser beam and laterally deflect the laser beam.

The orientation stop can itself be designed differently. It is thus advantageous in particular for retrofitting angle measuring devices if the orientation stop forms a modular unit separate from the angle measuring device having a receptacle for the angle measuring device. It is merely to be ensured in this case that the receptacle specifies a corresponding alignment of the angle measuring device in relation to the orientation stop. If the orientation stop is part of the angle measuring device, mounting the orientation stop on the housing of the angle measuring device so it is adjustable between an idle position and a working position is thus advisable, in order to obtain smaller external dimensions for the storage and the transportation.

With the displacement of the orientation stop between a working position and an idle position, simple design conditions result for providing the orientation stop with a closure for the laser outlet opening in the housing of the angle measuring device, which covers this laser outlet opening in a protective manner when the orientation stop is displaced into its idle position.

### BRIEF DESCRIPTION OF THE DRAWINGS

The subject matter of the invention is illustrated by way of example in the drawings. In the figures

FIG. 1 shows a device according to the invention in a partially cutaway front view,

FIG. 2 shows this device in an end-face view,

FIG. 3 shows the device according to FIGS. 1 and 2 in a rear view in a smaller scale,

FIG. 4 shows an embodiment variant of a device according to the invention in a schematic front view,

FIG. 5 shows the device according to FIG. 4 in an end-face view in a larger scale,

FIG. 6 shows an illustration of a further design variant of the device according to the invention corresponding to FIG. 4, and

FIG. 7 shows an end-face view of the device according to FIG. 6.

### WAYS OF EMBODYING THE INVENTION

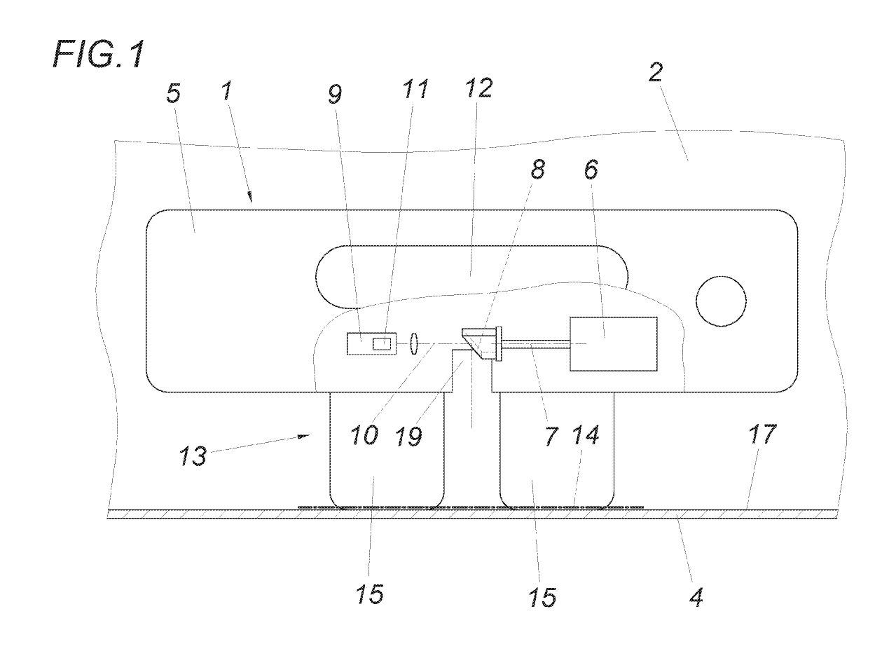

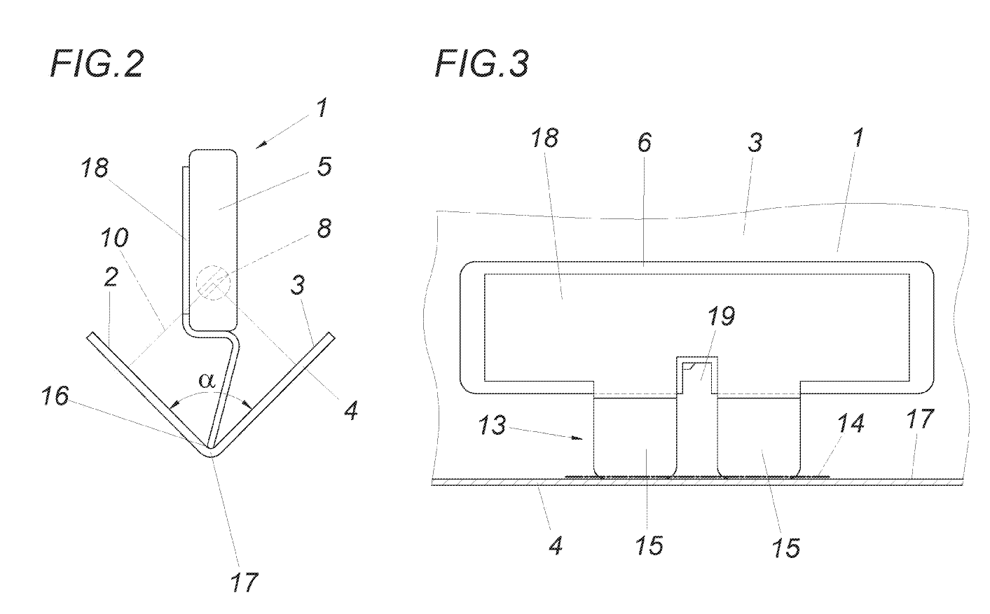

As can be inferred from FIGS. 1 and 2, the angle measuring device 1 for determining the angle α between two planar workpiece faces 2, 3, for example, of a plate 4 bent with the aid of a stamp and a die, has a housing 5, in which all means required for the measurement and the measurement display are combined. In a solely schematic illustration, these means comprise a mirror 8 drivable by a motor 6 about an axis of rotation 7 and a laser emitter 9 for a laser beam 10, which is incident on the mirror 8 in the direction of the axis of rotation 7 in order to be deflected perpendicularly to the axis of rotation 7. The deflected laser beam 10 passes over the two workpiece faces 2, 3 in the case of an alignment of the axis of rotation 7 of the mirror 8 parallel to the vertex axis of the angle α to be measured along straight lines perpendicular to the vertex axis and intersecting in the vertex axis, which enclose the angle α between them. The laser beam 10 incident on the workpiece faces 2, 3 is reflected on the respective workpiece face 2, 3, wherein exclusively the laser beam 10 reflected in the direction of incidence, i.e., the laser beam 10 reflected perpendicular to the workpiece plane 2, 3, is analyzed for the angle determination via a receiving unit 11, by associating the rotational position of the mirror 8 with this reflected laser beam 10. The measurement result is displayed in a display 12.

One condition for an error-free measurement procedure is that the housing 6 of the angle measuring device 1 can be aligned having the axis of rotation 7 for the mirror 8 precisely parallel to the vertex axis of the angle α between the two workpiece planes 2, 3, which is difficult in the case of a measuring device designed as a handheld device without corresponding aids. An orientation stop 13 is therefore associated with the angle measuring device 1, which defines at least one stop straight line 14, which is parallel to the axis of rotation 7 of the mirror 8, for the two workpiece planes. According to the exemplary embodiment of FIGS. 1 to 3, the orientation stop 13 forms for this purpose an orientation ruler from two stop sections 15 on both sides of the plane of the deflected laser beam 10 defined by the rotating mirror 8, wherein the contact edges 16 of these stop sections 15 define the stop straight line 14. If the orientation ruler formed from the two stop sections 15 is accordingly placed between the two workpiece planes 2, 3 with the contact edges 16 on the intersection edge 17 between the two workpiece planes 2, 3, the angle measuring device 1 can thus be held aligned correctly for measurement in relation to the workpiece planes 2, 3 in a simple manner.

The orientation stop 13 according to FIGS. 1 to 3 is formed as a module separate from the angle measuring device 1, which has an angle receptacle 18 for the formfitting fastening of the housing 5. The mounting of the housing 5 in the receptacle 18 can preferably be performed with the aid of permanent magnets, but this is not required. The two stop sections 15 of the orientation ruler protrude correspondingly from the angled receptacle 18, so that the laser outlet opening 19 of the housing 5 is located at a corresponding distance from the intersection edge 17 between the two workpiece planes 2, 3, in order to achieve good measuring conditions. In order that the laser beam 10 can also be emitted perpendicularly onto both workpiece planes 2, 3 in the case of shorter angle legs, the distance of the axis of rotation 7 of the mirror 8 from the vertex axis of the angle α to be measured can be restricted by the orientation stop 13. For this purpose, the distance of the axis of rotation 7 of the mirror 8 from the stop straight lines can be 10 to 80 mm, preferably 10 to 40 mm.

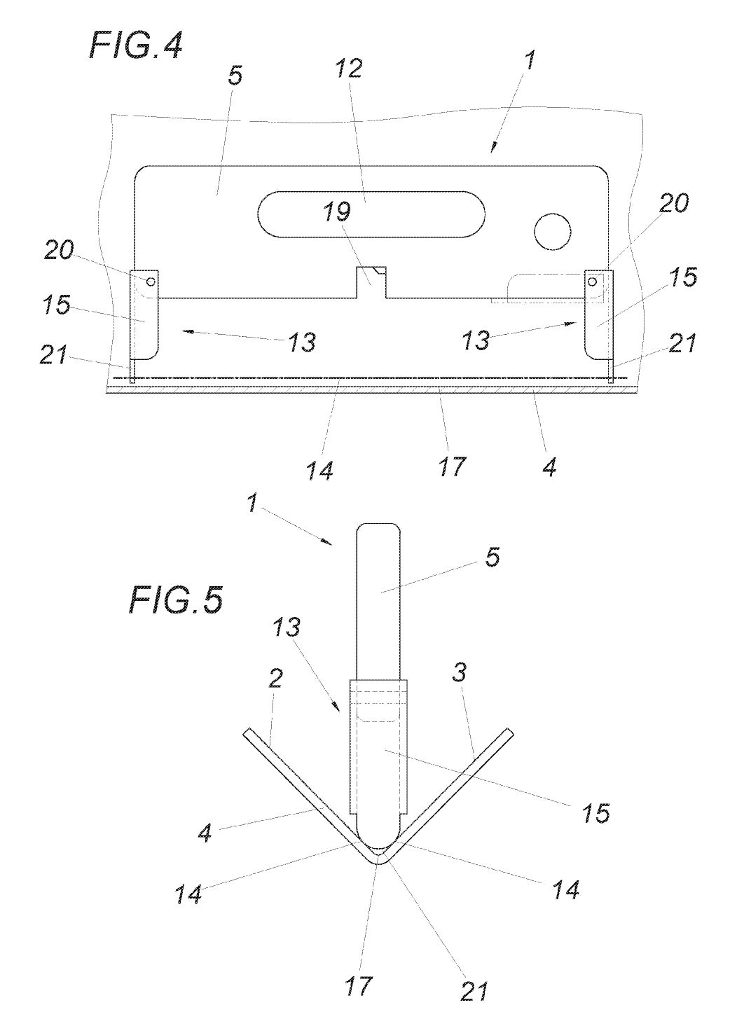

As the exemplary embodiment according to FIGS. 4 and 5 shows, it is also possible to provide the angle measuring device 1 itself with the orientation stop 13. For this purpose, two stop sections 15 are in turn mounted on the housing 5 so they are pivotable around axes 20. This means that the stop sections 15 can be pivoted out from an idle position indicated by a dot-dash line into the operating position shown by solid lines.

In contrast to the exemplary embodiment according to FIGS. 1 to 3, the two stop sections 15 define a stop cylinder 21, because they have a semicircular shape in a plane perpendicular to the vertex axis of the angle α. As can be inferred from FIG. 5, two stop straight lines 14 each formed by one generator of the stop cylinder 21 result due to this stop cylinder 21, via which the orientation stop 13 is supported on the two workpiece planes 2 and 3. An accurate measurement alignment of the angle measuring device 1 in relation to the workpiece planes 2, 3 is also ensured in this case upon placement of the orientation stop 13 on the two workpiece planes 2, 3.

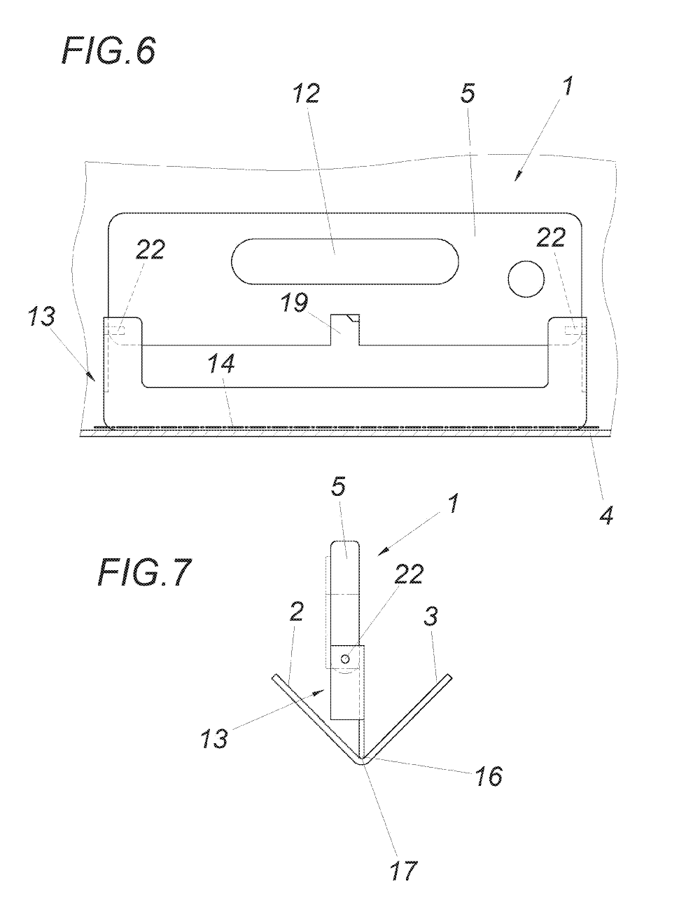

An orientation stop 13 corresponding in its action to the embodiment according to FIGS. 1 to 3 results according to FIGS. 6 and 7, which forms a continuous orientation ruler, the contact edge 16 of which interacts with the intersection edge 17 between the workpiece planes 2 and 3, as can be inferred from FIG. 7 in particular. The orientation stop 13 is mounted so it is pivotable on the housing 5 around axes 22, which extend parallel to the stop straight lines 14 formed by the orientation ruler.

1. A device for aligning an angle measuring device (1) in relation to two workpiece planes (2, 3) enclosing an angle to be measured, wherein the angle measuring device (1) has a rotating mirror (8) for deflecting a laser beam (10) perpendicular to the axis of rotation (7) of the mirror (8), characterized in that an orientation stop (13) is assigned to the angle measuring device (1), which orientation stop (13) defines a stop straight line (14) parallel to the axis of rotation (7) of the mirror (8) for both workpiece planes (2, 3).

2. The device according to claim 1, characterized in that the orientation stop (13) forms an orientation ruler which can be supported on the inner side of an intersection edge (17) between the workpiece planes (2, 3).

3. The device according to claim 1, characterized in that the orientation stop (13) forms a stop cylinder (21) which is parallel to the axis of rotation (7) of the mirror (8).

4. The device according to any one of claims 1 to 3, characterized in that the orientation stop (13) has two stop sections (15) on both sides of the plane of the deflected laser beam (10) defined by the rotating mirror (8).

5. The device according to any one of claims 1 to 4, characterized in that the orientation stop (13) forms a module separate from the angle measuring device (1), having a receptacle (18) for the angle measuring device (1).

6. The device according to any one of claims 1 to 3, characterized in that the orientation stop (13) is mounted on the housing (5) of the angle measuring device (1) in such a way, that the orientation stop (13) is displaceable between an idle position and a working position.

7. The device according to claim 6, characterized in that in its idle position the orientation stop (13) forms a closure for covering the laser outlet opening (19) in the housing (5) of the angle measuring device (1).
